(19) United States
(12) Patent Application Publication
(10) Pub. No.: US 2016/0300068 A1
(43) Pub. Date: Oct. 13, 2016

(54) System and Method to View Encrypted Information on a Security Enabled Display Device

(71) Applicant: Dell Products, LP, Round Rock, TX (US)

(72) Inventors: Kurt D. Gillespie, Pflugerville, TX (US); J. Bret Barkelew, Austin, TX (US); David W. Smith, Leander, TX (US)

(21) Appl. No.: 14/680,570

(22) Filed: Apr. 7, 2015

(51) Int. Cl. G06F 21/60; H04N 5/265; H04N 5/262; H04N 1/44

(52) U.S. Cl. CPC G06F 21/602; H04N 1/4486; H04N 5/265; H04N 5/2628

(57) ABSTRACT

A secure display device includes a display and a decoder. The secure display device receives encoded content that includes information that encodes a secure image, and provides the encoded content to the decoder. The decoder decodes the encoded content to retrieve the secure image, and sends the secure image to the display. The display shows the secure image.

### FIELD OF THE DISCLOSURE

This disclosure generally relates to information handling systems, and more particularly relates to a system and method to view encrypted information on a security enabled display device.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a secure content delivery system according to an embodiment of the present disclosure;

FIGS. 2 and 3 are illustrations of display device displays according to various embodiments of the present disclosure;

FIGS. 4 and 5 are block diagrams of secure display devices according to various embodiments of the present disclosure;

FIG. 6 is a block diagram of a secure content delivery system according to various embodiments of the present disclosure; and

FIG. 7 is a block diagram illustrating a generalized information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

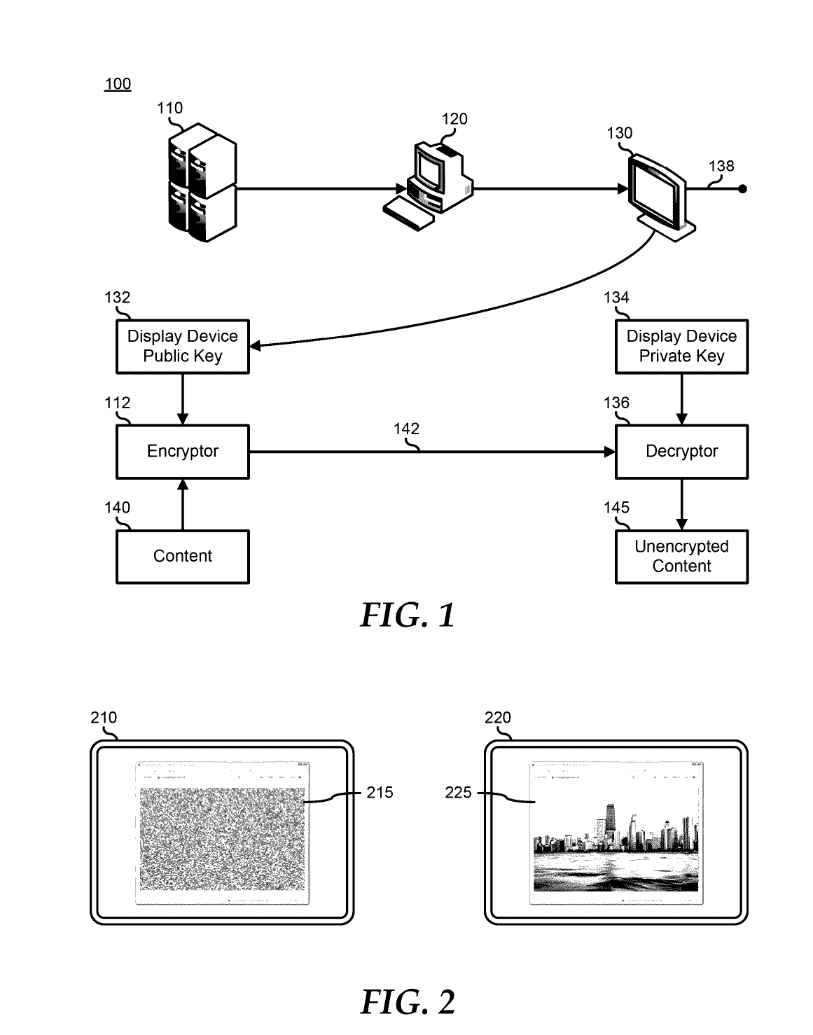

FIG. 1 illustrates an embodiment of a secure content delivery system 100. For purpose of this disclosure, secure content delivery system 100 can represented as an information handling system that includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch router or other network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. An information handling system can also include one or more buses operable to transmit information between the various hardware components.

Secure content delivery system 100 includes a secure content server 110, an information handling system 120, and a secure display device 130. Secure content server 110 operates to encode content and send the encoded content to information handling system 120. Information handling system 120 operates to receive the encoded content and to pass the encoded content to secure display device 130. Secure display device operates to receive the encoded content from information handling system 120, to decode the content, and to display the content for viewing by a user of secure content delivery system 100. Here, secure content server 110 represents a source of content, which, for the purpose of this disclosure, can include pictures or video content, document or text content, presentation content, spreadsheet content, database content, or any other content that is viewable on a display device. For example, the content can include image or video files in accordance with a wide variety of image file formats such as GIF files, bitmap files, JPEG files, MPEG files, or other image or video files, office productivity documents, presentations, spreadsheets, databases, or other office productivity files, or the like, as needed or desired. Here, information handling system 120 operates without any knowledge that the content has been encoded by secure content server 110 or that the content will be decoded by secure display device 130, but merely passes the encoded content between the secure content server and the secure display device without special processing of the encoded content.

In a particular embodiment, also shown in FIG. 1, secure content server 110 and secure display device 130 operate to secure the content using an asymmetric encryption scheme, such as a Public Key Infrastructure (PKI) encryption scheme. Here, secure display device 130 provides a public key 132 to secure content server 110 during a setup process. Secure content server 110 includes an encryptor 112 that uses public key 132 to encrypt content 140 requested by the information handling system 120. The encrypted content 142 is provided via information handling system 120 to secure display device 130. Secure display device 130 includes a decryptor 136 that uses a private key 134 that resides within the secure display device to decrypt encrypted content 142 to obtain the unencrypted content 145 for display.

In a particular embodiment, a manufacturer of secure display device 130 provides an enrollment service or clearing house for storing public key 132, such that a provider of content 140 can access the enrollment service or clearing house to obtain the public key that is associated with the secure display device. In this way, multiple providers can provide content 140 securely without special equipment or trust in the devices and systems that handle the content between secure content server 110 and secure display device 130. In another embodiment, the manufacturer of secure display device 130 provides access to public key 132 via physical access to the secure display device. For example, secure display device 130 can include a Quick Response (QR) code that includes public key 132, or that includes a URL for a web site from which a provider of content 140 can acquire the public key. In this way, a physical layer of security is added, in that public key 132 is not available unless the provider of content 140 has physical access to secure display device 130. In yet another embodiment, secure display device 130 includes a service port 138 that permits a user of the secure display device to program the secure display device with a particular private key 134. In this way, a user with multiple secure display devices similar to secure display device 130 can provide a standard private key 134 to all of the secure display devices, so that each of the secure display devices can view the same encrypted content. In yet another embodiment, secure display device 130 supports multiple public/private key pairs so that the secure display device can view content from different sources.

FIG. 2 illustrates two different display device displays 210 and 220. Display 210 represents a display of a standard display device. Here, encrypted content is received, but, because the data associated with the content is encrypted as pixel data, a window 215 that is instantiated on the display appears to the viewer as random information or noise. Display 220 represents a display of secure display device 130. Here, encrypted content is received and decoded, and a window 225 on the display appears to the viewer as the unencrypted content. In this way, the visual representation of the encoded content is protected against unauthorized access, while utilizing standard delivery methods like a web browser or an unmodified information handling system 120. For example, where a man-in-the-middle attack seeks to intercept the stream of content from information handling system 120 and secure display device 130 by tapping into a video cable between the information handling system and the secure display device, the fact that the content that is traversing the cable is still encoded means that the man-in-the-middle attack will fail to reveal the encoded content. For another example, where a man-in-the-middle attack seeks to intercept the stream of content from within information handling system 120 by use of malware that can view the graphics framebuffer, the fact that the content that is rendered is still encoded means that the man-in-the-middle attack will fail to reveal the encoded content. As such, trust of a partially or fully compromised information handling system 120 is not a factor, and is unneeded by the owner of the content or by the end viewer of the content. Moreover information handling system 120 can be ignorant of the fact that the encoded visual content is in fact encoded, and can merely handle the content in the same manner as with any other visual content, regardless of whether the content is viewed as noise, as in display 210, or as it was visually intended in its unencrypted form, as in display 220.

Although secure content server 110, information handling system 120, and secure display device 130 are represented as separate devices, this is not necessarily so. For example, information handling system 120 can encode content using public key 132, and can send the encoded content to secure display device 130 for decoding and display to a user. In another example, secure display device 130 can be integrated with information handling system 120 into a single device, such as a laptop computer, a tablet device, or a mobile device, but where the decryption of encrypted content is performed downstream from a video interface of the information handling system.

Further, the encoded content can take multiple forms. For example, the encoded content can represent content to be displayed on a whole screen of display device 130, such as where information handling system 120 does not support a windowed type of operating system. An example may be a dedicated viewer of secure content, where the encoded content represents encoded pixel data that is decoded pixel-by-pixel in secure display device 130 for display to a user. In another example, the encoded content can represent complete encodings of a particular type of content file. Here, for example, the content can be a JPEG file, and secure content server 110 can encrypt the entire JPEG file. In this case, secure display device 130 is presumed to have a native capability of handling JPEG files. Here, the very fact that the content is a JPEG file can remain secret until it is received by secure display device 130. Then, when secure display device 130 receives the encrypted content, the secure display device 130 decrypts the content to recover the JPEG file, and then displays the image data contained in the JPEG file.

In yet another example, the encoded content can represent encoding of data within a particular type of content file. Here, again using the JPEG example, secure content server 110 can encrypt an image, and then encapsulate the encrypted image into a JPEG file. In this respect, the fact that the content is a JPEG file may be discoverable, but the content of the JPEG file remains encrypted. In this case, information handling system 120 can receive the JPEG file, and can prepare the encrypted content of the JPEG file for display on secure display device 130 similarly with any other content that is displayed on the secure display device (i.e., in a particular window, etc.). Then, when secure display device 130 receives a frame of content from information handling system 120, the portion of the frame that includes the encrypted data can be decrypted by secure display device 130 on a pixel-by-pixel to display the image. In this case, secure display device 130 receives additional information to determine which portions of the display screen need to be decrypted, and which portions do not need to be decrypted.

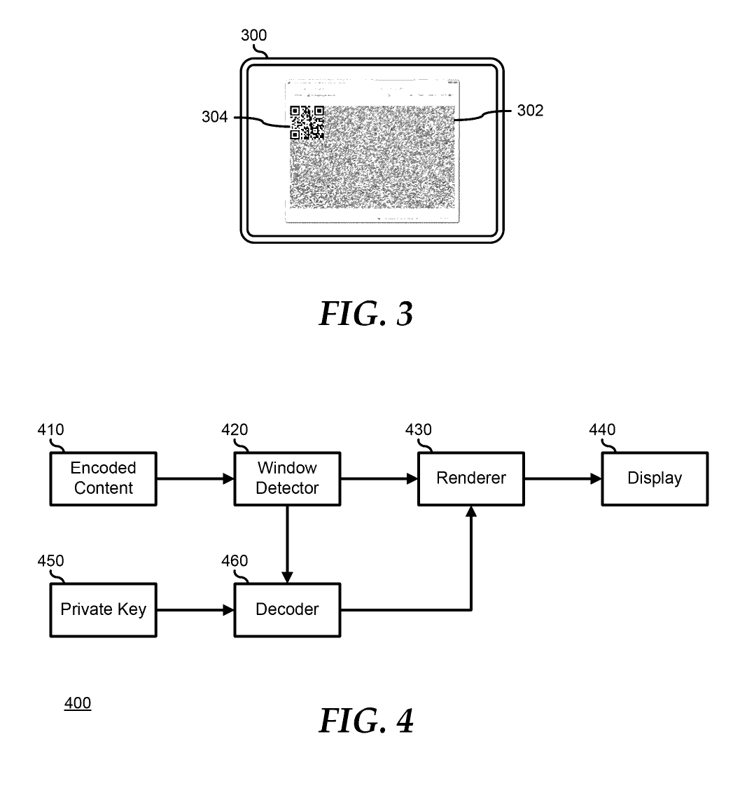

FIG. 3 illustrates a display device display 300 similar to display 220. Here, encrypted content is received and displayed on a window 302 that is instantiated on display 300. In addition to the encoded pixel data, the encoded content includes one or more secure content identifier 304 that locates a starting screen location for the encoded content, and a display size for the encoded content. For example, secure content identifier 304 can be represented as a Quick Response (QR) code at the beginning of the encoded content that identifies the size and shape of the unencrypted image that has been encoded. With this information, secure display device 130 operates to selectively engage decryption for the encoded content and disengage the decryption for the unencrypted content.

FIG. 4 illustrates an embodiment of a secure display device 400, similar to secure display device 130, and including received encoded content 410, a secure content window detector 420, a renderer 430, a display 440, a private key 450, and a decoder 460. Encoded content 410 can include one or more secure content identifier similar to secure content identifier 304. Here, encoded content 410 is provided to secure content window detector 420 to determine if the received content, or a subset of the received content, is encoded and to determine the size and shape of the image of the encoded content based on the secure content identifier. Pixel data for each section of secure content that is identified as being encoded by the secure content identifier are routed to decoder 460, which, with private key 550, decodes the pixel data for each section of secure content. Secure content window detector 420 also identifies the size and shape of the encoded content to renderer 430, the renderer renders the decoded content, the secure image, in the location, size and shape identified by the secure content window detector, and provides the full frame to display 440.

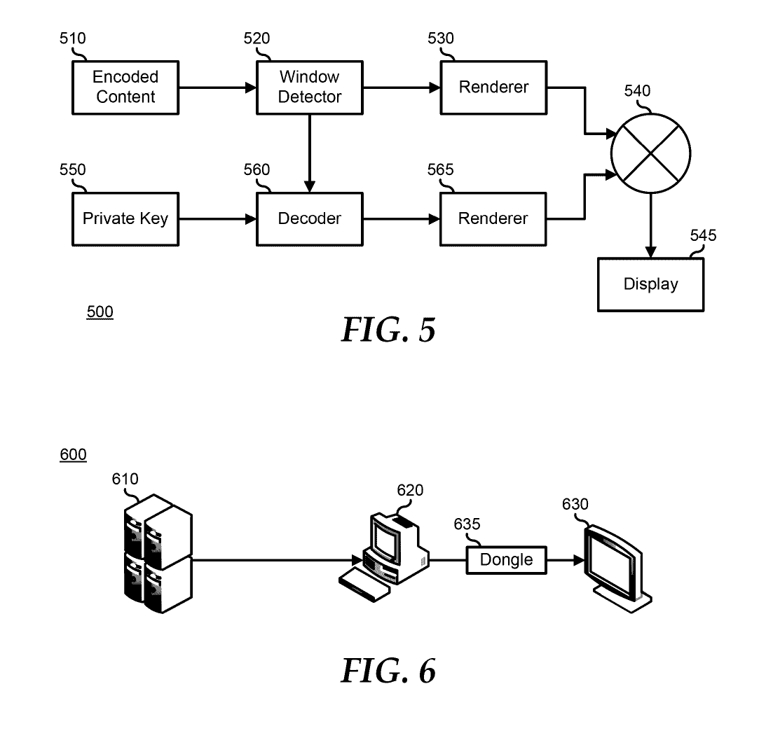

FIG. 5 illustrates an embodiment of a secure display device 500, similar to secure display device 400, and including received encoded content 510, a secure content window detector 520, renderers 530 and 565, a video mixer 540, a private key 550, a decoder 560, and a display 545. Encoded content 510 is similar to encoded content 410 and includes a secure content identifier similar. Here, encoded content 510 is provided to secure content window detector 520 to determine if the received content, or a subset of the received content, is encoded and to determine the size and shape of the image of the encoded content based on the secure content identifier. Pixel data for each section of secure content that is identified as being encoded by the secure content identifier are routed to decoder 560, which, with private key 550, decodes the pixel data for each section of secure content. The decoded pixel data is rendered in renderer 560, the unencoded content is rendered in renderer 530, and mixer 540 overlays the rendered decoded content, the secure image, onto the rendered unencoded content and provides the full frame to display 545.

FIG. 6 illustrates an embodiment of a secure content delivery system 600 similar to secure content delivery system 100, and including a secure content server 110, an information handling system 620, a secure content dongle 635, and a display device 630. Secure content delivery system 600 operates similarly to secure content delivery system 100 except that the security features of secure display device 130 are not reproduced in display device 630. Here, display device 630 represents a standard display device, and secure content dongle 635 represents an in-line device that provides the security features of secure display device 130, as described above. In this way, the data security features of the present disclosure can be provided to a standard display device, such as a video monitor, a high-definition television, or another display device, as needed or desired.

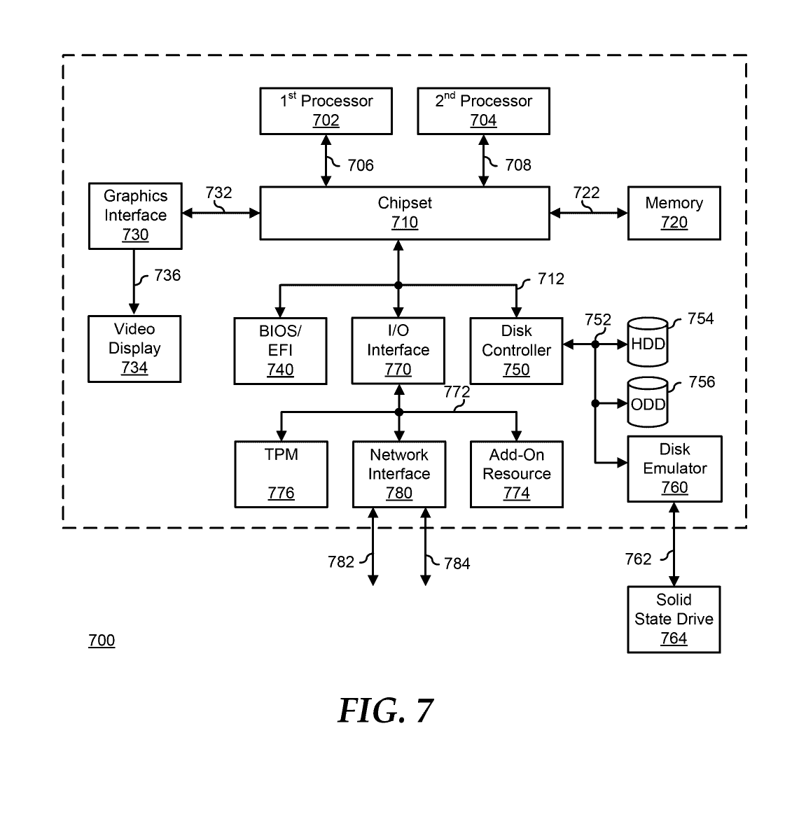

FIG. 7 illustrates a generalized embodiment of information handling system 700. For purpose of this disclosure information handling system 700 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 700 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 700 can include processing resources for executing machine-executable code, such as a central processing unit (CPU), a programmable logic array (PLA), an embedded device such as a System-on-a-Chip (SoC), or other control logic hardware. Information handling system 700 can also include one or more computer-readable medium for storing machine-executable code, such as software or data. Additional components of information handling system 700 can include one or more storage devices that can store machine-executable code, one or more communications ports for communicating with external devices, and various input and output (I/O) devices, such as a keyboard, a mouse, and a video display. Information handling system 700 can also include one or more buses operable to transmit information between the various hardware components.

Information handling system 700 can include devices or modules that embody one or more of the devices or modules described above, and operates to perform one or more of the methods described above. Information handling system 700 includes a processors 702 and 704, a chipset 710, a memory 720, a graphics interface 730, include a basic input and output system/extensible firmware interface (BIOS/EFI) module 740, a disk controller 750, a disk emulator 760, an input/output (I/O) interface 770, and a network interface 780. Processor 702 is connected to chipset 710 via processor interface 706, and processor 704 is connected to the chipset via processor interface 708. Memory 720 is connected to chipset 710 via a memory bus 722. Graphics interface 730 is connected to chipset 710 via a graphics interface 732, and provides a video display output 736 to a video display 734. In a particular embodiment, information handling system 700 includes separate memories that are dedicated to each of processors 702 and 704 via separate memory interfaces. An example of memory 720 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 740, disk controller 750, and I/O interface 770 are connected to chipset 710 via an I/O channel 712. An example of I/O channel 712 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 710 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 740 includes BIOS/EFI code operable to detect resources within information handling system 700, to provide drivers for the resources, initialize the resources, and access the resources. BIOS/EFI module 740 includes code that operates to detect resources within information handling system 700, to provide drivers for the resources, to initialize the resources, and to access the resources.

Disk controller 750 includes a disk interface 752 that connects the disc controller to a hard disk drive (HDD) 754, to an optical disk drive (ODD) 756, and to disk emulator 760. An example of disk interface 752 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 760 permits a solid-state drive 764 to be connected to information handling system 700 via an external interface 762. An example of external interface 762 includes a USB interface, an IEEE 1394 (Firewire) interface, a proprietary interface, or a combination thereof. Alternatively, solid-state drive 764 can be disposed within information handling system 700.

I/O interface 770 includes a peripheral interface 772 that connects the I/O interface to an add-on resource 774, to a TPM 776, and to network interface 780. Peripheral interface 772 can be the same type of interface as I/O channel 712, or can be a different type of interface. As such, I/O interface 770 extends the capacity of I/O channel 712 when peripheral interface 772 and the I/O channel are of the same type, and the I/O interface translates information from a format suitable to the I/O channel to a format suitable to the peripheral channel 772 when they are of a different type. Add-on resource 774 can include a data storage system, an additional graphics interface, a network interface card (NIC), a sound/video processing card, another add-on resource, or a combination thereof. Add-on resource 774 can be on a main circuit board, on separate circuit board or add-in card disposed within information handling system 700, a device that is external to the information handling system, or a combination thereof.

Network interface 780 represents a NIC disposed within information handling system 700, on a main circuit board of the information handling system, integrated onto another component such as chipset 710, in another suitable location, or a combination thereof. Network interface device 780 includes network channels 782 and 784 that provide interfaces to devices that are external to information handling system 700. In a particular embodiment, network channels 782 and 784 are of a different type than peripheral channel 772 and network interface 780 translates information from a format suitable to the peripheral channel to a format suitable to external devices. An example of network channels 782 and 784 includes InfiniBand channels, Fibre Channel channels, Gigabit Ethernet channels, proprietary channel architectures, or a combination thereof. Network channels 782 and 784 can be connected to external network resources (not illustrated). The network resource can include another information handling system, a data storage system, another network, a grid management system, another suitable resource, or a combination thereof.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A secure display device comprising:
a display; and
a decoder;
wherein the secure display device receives encoded content that includes a secure image, the secure display device provides the encoded content to the decoder, the decoder decodes the encoded content to retrieve the secure image, the decoder sends the secure image to the display, and the display shows the secure image.

2. The secure display device of claim 1, wherein further, the encoded content includes a secure content identifier that identifies a size and a shape of the secure image

3. The secure display device of claim 2, further comprising:
a secure content window detector that determines the size and the shape from the secure content identifier.

4. The secure display device of claim 3, wherein further the secure content window detector provides the size and the shape to the decoder.

5. The secure display device of claim 4, further comprising:
a renderer;
wherein the decoder sends the secure image to the display via the renderer.

6. The secure display device of claim 5, wherein further:
the secure content window detector provides the size and the shape to the renderer; and
the renderer renders the secure image into a frame based on the size and the shape, and sends the frame to the display.

7. The secure display device of claim 4, further comprising:
a first renderer;
a second renderer; and
a video mixer;
wherein, the first renderer renders unencoded content, the secure content window detector provides the size and the shape to the second renderer, the second renderer renders the secure image, and the mixer mixes the unencoded content and the secure image into a frame based on the size and the shape, and sends the frame to the display.

8. The secure display device of claim 1, further comprising:
a private key of an asymmetrical encryption scheme;
wherein the encoded content is encoded using a public key of the asymmetrical encryption scheme, and the public key is associated with the private key, and the decoder decodes the encoded content based on the private key.

9. A method comprising:
receiving, at a secure display device, encoded content that includes a secure image;
providing the encoded content to a decoder of the secure display device;
decoding the encoded content to retrieve the secure image;
sending the secure image to the display; and
showing, on a display of the secure display device, the secure image.

10. The method of claim 9, wherein the encoded content includes a secure content identifier that identifies a size and a shape of the secure image

11. The method of claim 10, further comprising:
determining, by a secure content window detector of the secure display device, the size and the shape from the secure content identifier.

12. The method of claim 11, further comprising:
providing the size and the shape to the decoder.

13. The method of claim 12, further comprising:
sending the secure image to the display via a renderer of the secure display device.

14. The method of claim 13, further comprising:
providing, by the secure content window detector, the size and the shape to the renderer;
rendering, by the renderer, the secure image into a frame based on the size and the shape; and
sending the frame to the display.

15. The method of claim 11, further comprising:
rendering, by a first renderer of the secure display device, unencoded content;
providing the size and the shape to a second renderer of the secure display device;
rendering, by the second renderer, the secure image;
mixing, by a mixer of the secure display device, the unencoded content and the secure image into a frame based on the size and the shape; and
sending the frame to the display.

16. The method of claim 9, wherein:
the encoded content is encoded using a public key of an asymmetrical encryption scheme; and
the decoder decodes the encoded content based on a private key of the asymmetrical encryption key that is associated with the public key.

17. A non-transitory computer-readable medium including code for performing a method, the method comprising:
receiving encoded content, the encoded content including a secure image and a secure content identifier that identifies a size and a shape of the secure image;
providing the encoded content to a decoder of a secure display device;
decoding the encoded content to retrieve the secure image;
sending the secure image to the display;
showing, on a display of the secure display device, the secure image; and
determining, by a secure content window detector of the secure display device, the size and the shape from the secure content identifier.

18. The computer-readable medium of claim 17, the method further comprising:
providing the size and the shape to the decoder.
sending the secure image to the display via a renderer of the secure display device.

19. The computer-readable medium of claim 18, the method further comprising:
rendering, by a first renderer of the secure display device, unencoded content;
providing the size and the shape to a second renderer of the secure display device;
rendering, by the second renderer, the secure image;
mixing, by a mixer of the secure display device, the unencoded content and the secure image into a frame based on the size and the shape; and
sending the frame to the display.

20. The computer-readable medium of claim 17, wherein:
the encoded content is encoded using a public key of an asymmetrical encryption scheme; and
the decoder decodes the encoded content based on a private key of the asymmetrical encryption key that is associated with the public key.
